(19) United States
(12) Patent Application Publication
(10) Pub. No.: US 2010/0157591 A1
(43) Pub. Date: Jun. 24, 2010

(54) Flourescent Lamp Whose Ballast and Reflective Shade are Detachable From Each Other

(76) Inventor: Wen-Hsin Chao, Homei Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/343,824

(22) Filed: Dec. 24, 2008

(51) Int. Cl. F21V 1/00

(52) U.S. Cl. 362/235

(57) ABSTRACT

A fluorescent lamp includes a reflective shade, a hollow base mounted on the reflective shade, a ballast detachably mounted on the base, at least one fluorescent tube detachably mounted on the ballast, and a mounting seat mounted on an opened end of the reflective shade and combined with the base to detachably clamp the reflective shade between the base and the mounting seat. Thus, the ballast is detachably mounted on the base, and the reflective shade is detachably mounted between the base and the mounting seat so that the ballast and the reflective shade are separated from each other and can be repaired and replaced individually.

### BACKGROUND OF THE INVENTION

1. Field of the Invention

The present invention relates to a lamp and, more particularly, to a fluorescent lamp.

2. Description of the Related Art

A conventional fluorescent lamp comprises a reflective shade, a ballast and a fluorescent tube. The ballast provides a determined starting voltage and a stabilized current to the fluorescent tube so that the fluorescent tube is lighted successively and stably. However, the ballast is directly fixed on the reflective shade, so that the ballast and the reflective shade are combined together and cannot be separated from each other. Thus, a user has to replace the ballast and the reflective shade simultaneously when one of the ballast and the reflective shade is worn out, thereby increasing the costs of replacement and maintenance of the ballast and the reflective shade.

### BRIEF SUMMARY OF THE INVENTION

In accordance with the present invention, there is provided a fluorescent lamp, comprising a reflective shade, a hollow base mounted on the reflective shade, a ballast detachably mounted on the base, and at least one fluorescent tube detachably mounted on the ballast.

The primary objective of the present invention is to provide a fluorescent lamp whose ballast and reflective shade (or bulb) are detachable from each other.

Another objective of the present invention is to provide a fluorescent lamp, wherein the ballast is detachably mounted on the base, and the reflective shade is detachably mounted between the base and the mounting seat so that the ballast and the reflective shade are separated from each other and can be repaired and replaced individually.

A further objective of the present invention is to provide a fluorescent lamp, wherein the ballast and the reflective shade are separated from each other so that the specifications and sizes of the ballast and the reflective shade can be selected individually, thereby decreasing the costs of fabrication and storage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a fluorescent lamp in accordance with the preferred embodiment of the present invention.

FIG. 2 is an exploded perspective view of the fluorescent lamp as shown in FIG. 1.

FIG. 3 is a front cross-sectional view of the fluorescent lamp as shown in FIG. 1.

FIG. 4 is a schematic operational view of the fluorescent lamp as shown in FIG. 1.

FIG. 5 is a schematic operational view of the fluorescent lamp as shown in FIG. 3.

FIG. 6 is a perspective view of a fluorescent lamp in accordance with the preferred embodiment of the present invention.

FIG. 7 is an exploded perspective view of the fluorescent lamp as shown in FIG. 6.

FIG. 8 is a locally enlarged view of the fluorescent lamp as shown in FIG. 7.

FIG. 9 is a locally enlarged view of the fluorescent lamp as shown in FIG. 7.

FIG. 10 is a front cross-sectional view of the fluorescent lamp as shown in FIG. 6.

FIG. 11 is a locally enlarged view of the fluorescent lamp as shown in FIG. 10.

### DETAILED DESCRIPTION OF THE INVENTION

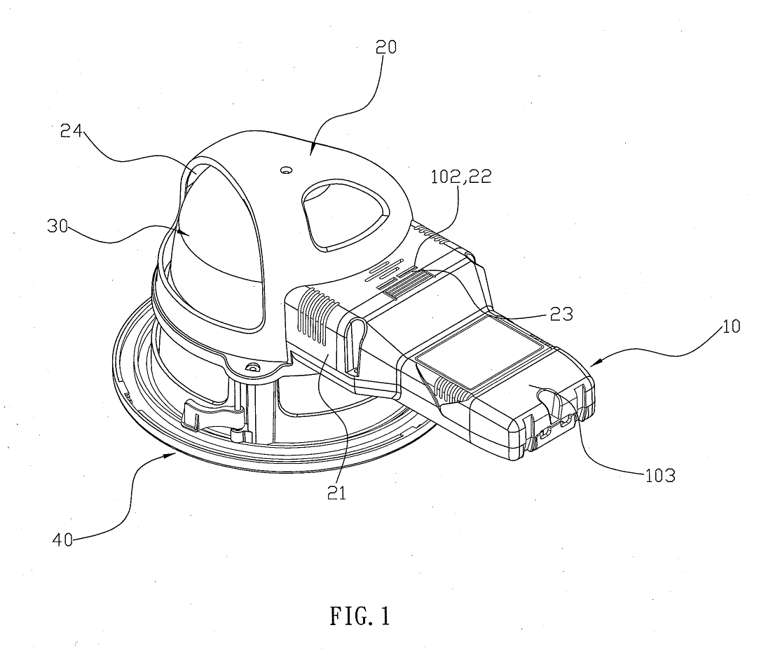

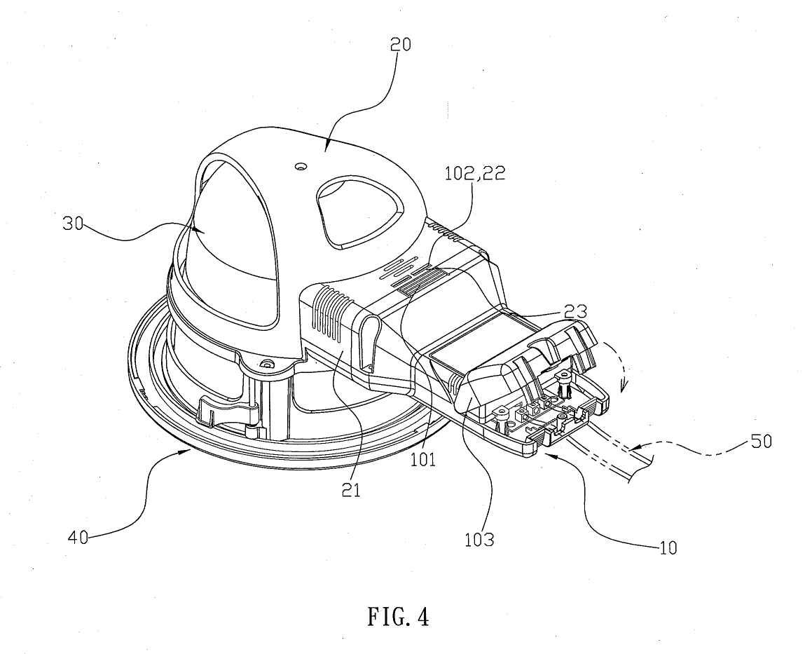

Referring to the drawings and initially to FIGS. 1-5, a fluorescent lamp in accordance with the preferred embodiment of the present invention comprises a reflective shade (or bulb) 30, a hollow base 20 mounted on the reflective shade 30, a ballast 10 detachably mounted on the base 20, at least one fluorescent tube 12 detachably mounted on the ballast 10 and extending through the base 20 into the reflective shade 30, and a mounting seat 40 mounted on an opened end of the reflective shade 30 and combined with the base 20 to detachably clamp the reflective shade 30 between the base 20 and the mounting seat 40.

The base 20 has a periphery provided with a hollow mounting portion 21. The mounting portion 21 of the base 20 is located at a side of the base 20. The mounting portion 21 of the base 20 has an inner portion provided with a receiving space 25 and has a periphery provided with at least one locking slot 22 which has a side provided with a locking edge 23. The locking slot 22 of the mounting portion 21 of the base 20 is connected to the receiving space 25. The base 20 has an inner portion provided with a receiving chamber 24 connected to the receiving space 25 of the mounting portion 21 to receive the reflective shade 30.

The reflective shade 30 has a periphery provided with an opening 31 located between and connected to the receiving space 25 of the mounting portion 21 and the receiving chamber 24 of the base 20. The opening 31 of the reflective shade 30 is located at a side of the reflective shade 30.

The ballast 10 has a side provided with at least one holder 11 to hold the fluorescent tube 12. The holder 11 of the ballast 10 is in line with a longitudinal direction of the ballast 10. The holder 11 of the ballast 10 is inserted into the receiving space 25 of the mounting portion 21 of the base 20 when the ballast 10 is mounted on the mounting portion 21 of the base 20. The ballast 10 provides a determined starting voltage and a stabilized current to the holder 11 so that the fluorescent tube 12 is lighted successively and stably. The ballast 10 has an inner portion provided with a circuit (not shown) that regulates the output power of the holder 11 so that the ballast 10 can co-operate with a single fluorescent tube 12 or two fluorescent tubes 12.

The ballast 10 is detachably mounted on the mounting portion 21 of the base 20. The ballast 10 has a periphery provided with a flexible locking plate 101 which has a distal end provided with at least one locking block 102. The locking block 102 of the locking plate 101 of the ballast 10 is detachably locked in the locking slot 22 of the mounting portion 21 and is limited by the locking edge 23 of the locking slot 22 to lock the locking plate 101 of the ballast 10 onto the mounting portion 21 of the base 20.

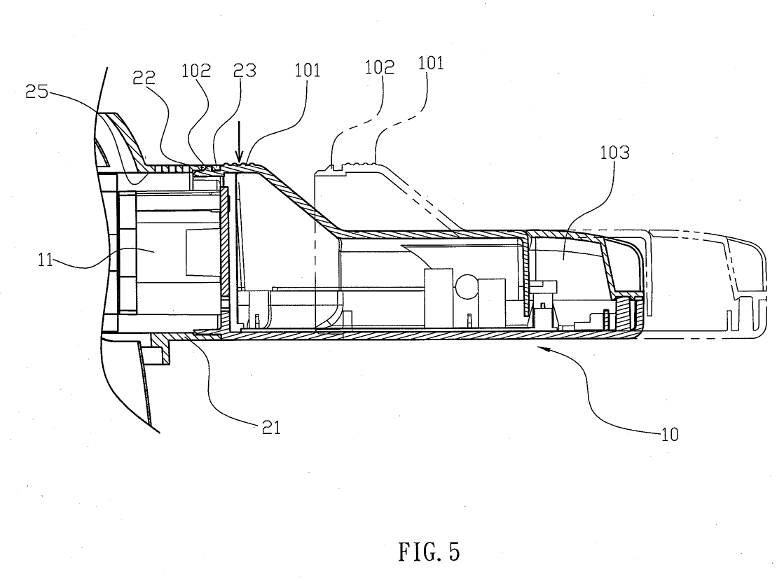

The locking block 102 of the locking plate 101 of the ballast 10 extends through the receiving space 25 into the locking slot 22 of the mounting portion 21 of the base 20. Thus, when the locking plate 101 of the ballast 10 is pressed and moved outwardly relative to the locking slot 22 of the mounting portion 21, the locking block 102 of the locking plate 101 is moved and detached from the locking slot 22 of the mounting portion 21 to unlock the locking plate 101 of the ballast 10 from the mounting portion 21 of the base 20 as shown in FIG. 5.

The fluorescent lamp further comprises a press piece 103 pivotally mounted on the ballast 10 to clamp a conducting wire 50 between the ballast 10 and the press piece 103 so as to fix the conducting wire 50 without needing aid of screws.

The fluorescent tube 12 is detachably attached to the holder 11 of the ballast 10 and in turn extends through the receiving space 25 of the mounting portion 21 of the base 20 and the opening 31 of the reflective shade 30 into the receiving chamber 24 of the base 20 when the ballast 10 is mounted on the mounting portion 21 of the base 20.

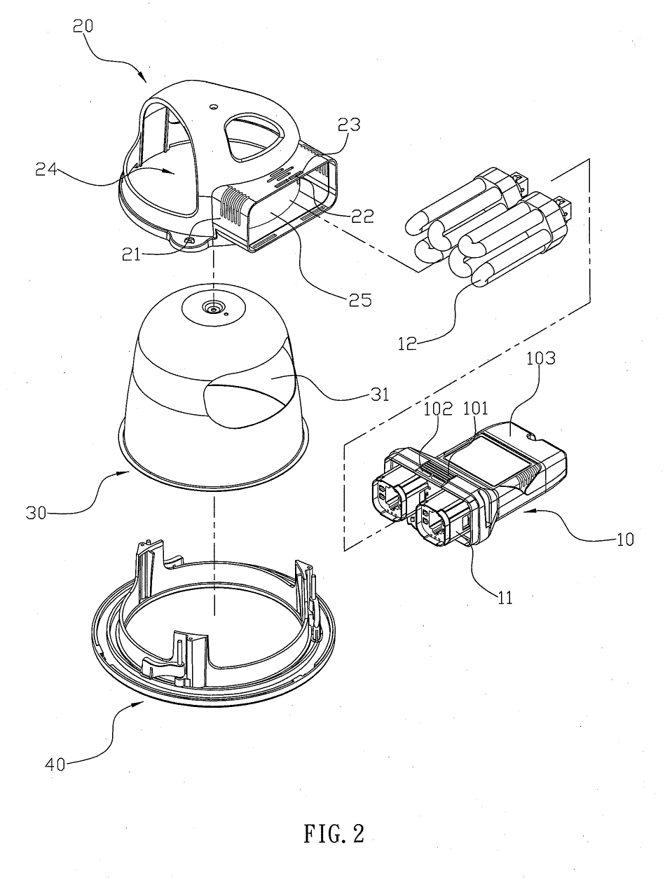

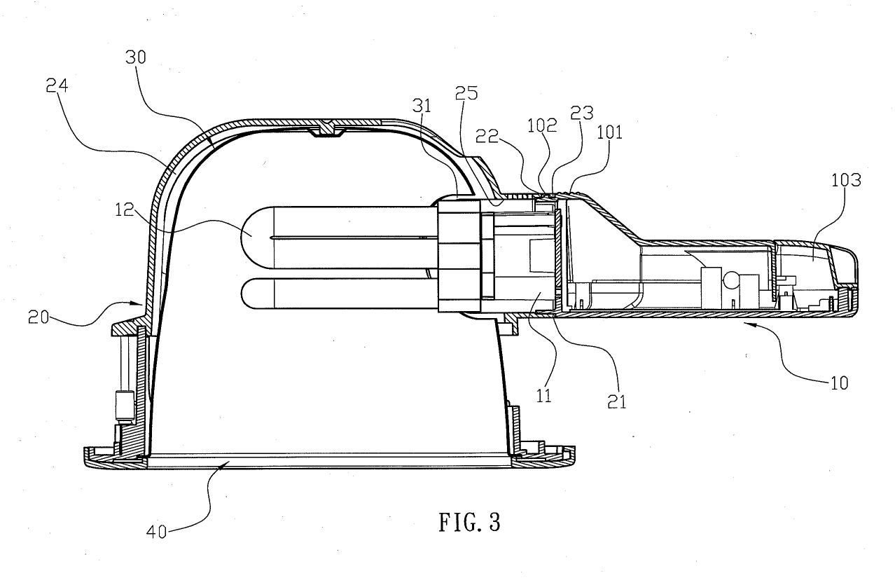

In assembly, referring to FIGS. 3-5 with reference to FIGS. 1 and 2, when the ballast 10 is mounted on the mounting portion 21 of the base 20, the holder 11 of the ballast 10 is inserted into the receiving space 25 of the mounting portion 21 of the base 20, and the fluorescent tube 12 in turn extends through the receiving space 25 of the mounting portion 21 of the base 20 and the opening 31 of the reflective shade 30 into the receiving chamber 24 of the base 20. At this time, the locking block 102 of the locking plate 101 of the ballast 10 extends through the receiving space 25 into the locking slot 22 of the mounting portion 21 of the base 20 so that the locking block 102 of the locking plate 101 of the ballast 10 is locked in the locking slot 22 of the mounting portion 21 and is limited by the locking edge 23 of the locking slot 22 to lock the locking plate 101 of the ballast 10 onto the mounting portion 21 of the base 20. On the contrary, when the locking plate 101 of the ballast 10 is pressed and moved outwardly relative to the locking slot 22 of the mounting portion 21, the locking block 102 of the locking plate 101 is moved and detached from the locking slot 22 of the mounting portion 21 to unlock the locking plate 101 of the ballast 10 from the mounting portion 21 of the base 20 so that the ballast 10 can be removed from the mounting portion 21 of the base 20 as shown in FIG. 5. Thus, the ballast 10 is detachably mounted on the base 20, and the reflective shade 30 is detachably mounted between the base 20 and the mounting seat 40 so that the ballast 10 and the reflective shade 30 are separated from each other and can be repaired and replaced individually.

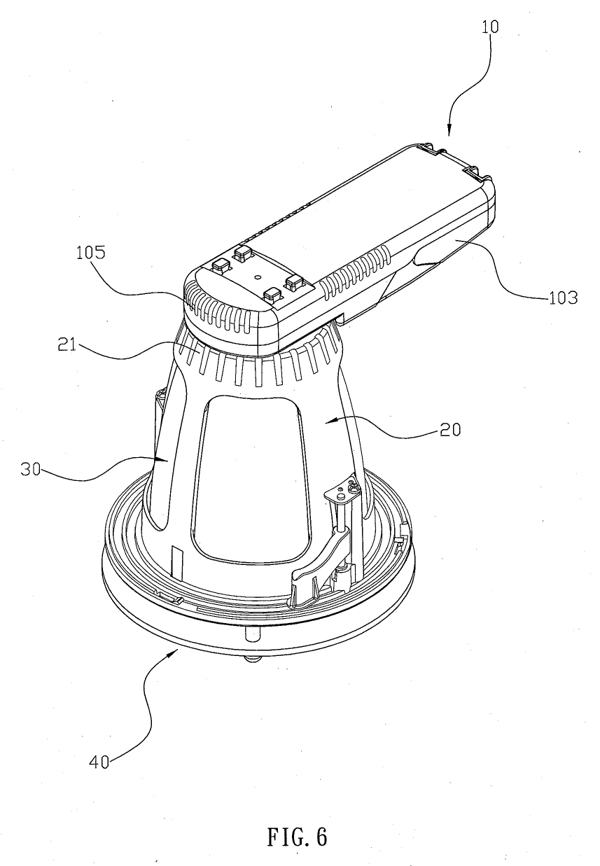

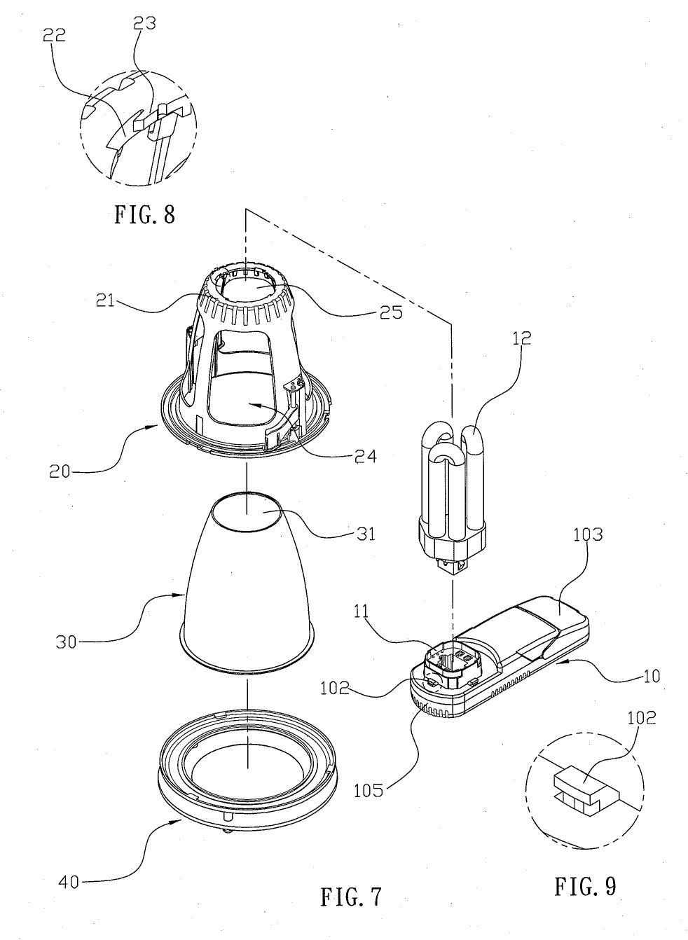

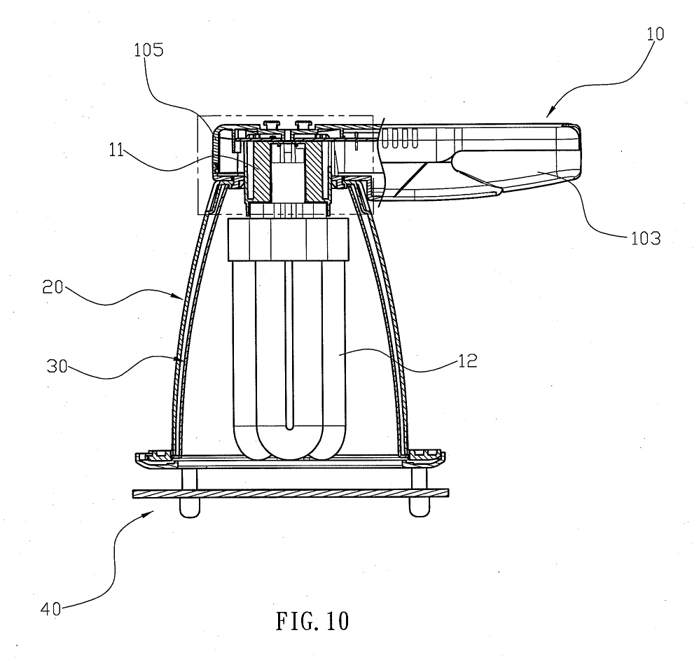

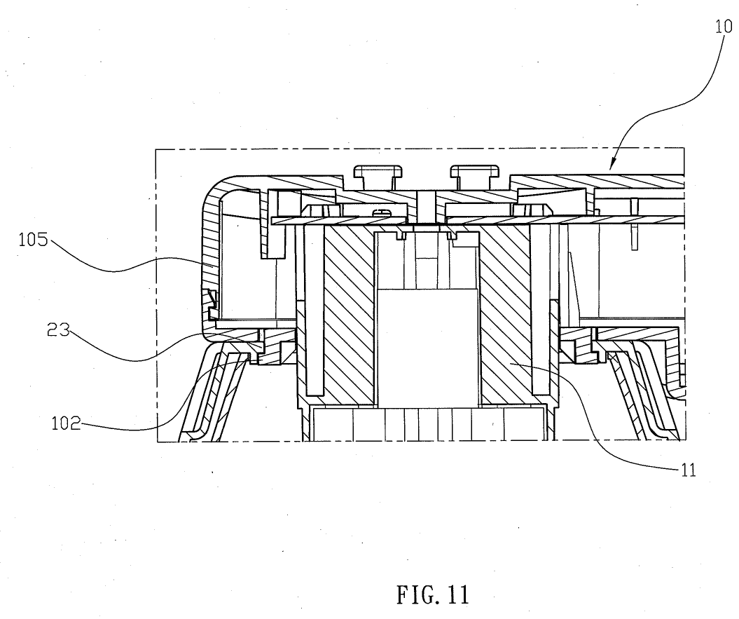

Referring to FIGS. 6-11, the holder 11 of the ballast 10 is perpendicular to the longitudinal direction of the ballast 10, the mounting portion 21 of the base 20 is located at a top of the base 20, and the opening 31 of the reflective shade 30 is located at a top of the reflective shade 30. The ballast 10 has a periphery provided with a rotation portion 105 which has a side provided with at least one locking block 102. The locking block 102 of the ballast 10 has a substantially L-shaped profile. The locking block 102 of the ballast 10 is inserted through the locking slot 22 of the mounting portion 21 and is locked onto the locking edge 23 of the locking slot 22 to lock the ballast 10 onto the mounting portion 21 of the base 20.

Thus, the rotation portion 105 of the ballast 10 is moved toward the locking slot 22 of the mounting portion 21, so that the locking block 102 of the ballast 10 is inserted through the locking slot 22 of the mounting portion 21, and the rotation portion 105 of the ballast 10 is then rotated relative to the mounting portion 21 of the base 20, so that the locking block 102 of the ballast 10 is moved to abut the locking edge 23 of the locking slot 22 to lock the ballast 10 onto the mounting portion 21 of the base 20. On the contrary, the rotation portion 105 of the ballast 10 is rotated relative to the mounting portion 21 of the base 20 in the reverse direction, so that the locking block 102 of the ballast 10 is detached from the locking edge 23 of the locking slot 22 and is moved to align with the locking slot 22 of the mounting portion 21. Then, the rotation portion 105 of the ballast 10 is moved outwardly relative to the locking slot 22 of the mounting portion 21, so that the locking block 102 of the ballast 10 is detached from the locking slot 22 of the mounting portion 21, and the ballast 10 is detached from the mounting portion 21 of the base 20.

Accordingly, the ballast 10 is detachably mounted on the base 20, and the reflective shade 30 is detachably mounted between the base 20 and the mounting seat 40 so that the ballast 10 and the reflective shade 30 are separated from each other and can be repaired and replaced individually. In addition, the ballast 10 and the reflective shade 30 are separated from each other so that the specifications and sizes of the ballast 10 and the reflective shade 30 can be selected individually, thereby decreasing the costs of fabrication and storage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fluorescent lamp, comprising:
a reflective shade;
a hollow base mounted on the reflective shade;
a ballast detachably mounted on the base;
at least one fluorescent tube detachably mounted on the ballast.

2. The fluorescent lamp of claim 1, further comprising:
a mounting seat mounted on an opened end of the reflective shade and combined with the base to detachably clamp the reflective shade between the base and the mounting seat.

3. The fluorescent lamp of claim 1, wherein
the base has a periphery provided with a hollow mounting portion;
the ballast is detachably mounted on the mounting portion of the base.

4. The fluorescent lamp of claim 3, wherein
the mounting portion of the base has an inner portion provided with a receiving space and has a periphery provided with at least one locking slot which has a side provided with a locking edge;
the ballast has a periphery provided with a flexible locking plate which has a distal end provided with at least one locking block;
the locking block of the locking plate of the ballast is detachably locked in the locking slot of the mounting portion and is limited by the locking edge of the locking slot to lock the locking plate of the ballast onto the mounting portion of the base.

5. The fluorescent lamp of claim 4, wherein the base has an inner portion provided with a receiving chamber connected to the receiving space of the mounting portion to receive the reflective shade.

6. The fluorescent lamp of claim 4, wherein
the locking slot of the mounting portion of the base is connected to the receiving space;
the locking block of the locking plate of the ballast extends through the receiving space into the locking slot of the mounting portion of the base;
the locking plate of the ballast is pressed and moved outwardly relative to the locking slot of the mounting portion, so that the locking block of the locking plate is moved and detached from the locking slot of the mounting portion to unlock the locking plate of the ballast from the mounting portion of the base.

7. The fluorescent lamp of claim 1, further comprising:
a press piece pivotally mounted on the ballast to clamp a conducting wire between the ballast and the press piece.

8. The fluorescent lamp of claim 4, wherein
the ballast has a side provided with at least one holder to hold the fluorescent tube;
the fluorescent tube is detachably attached to the holder of the ballast.

9. The fluorescent lamp of claim 8, wherein the holder of the ballast is inserted into the receiving space of the mounting portion of the base when the ballast is mounted on the mounting portion of the base.

10. The fluorescent lamp of claim 5, wherein
the reflective shade has a periphery provided with an opening located between and connected to the receiving space of the mounting portion and the receiving chamber of the base;
the fluorescent tube extends through the base into the reflective shade;
the fluorescent tube extends through the receiving space of the mounting portion of the base and the opening of the reflective shade into the receiving chamber of the base.

11. The fluorescent lamp of claim 8, wherein the holder of the ballast is in line with a longitudinal direction of the ballast.

12. The fluorescent lamp of claim 10, wherein
the mounting portion of the base is located at a side of the base;
the opening of the reflective shade is located at a side of the reflective shade.

13. The fluorescent lamp of claim 3, wherein
the mounting portion of the base has an inner portion provided with a receiving space and has a periphery provided with at least one locking slot which has a side provided with a locking edge;
the ballast has a periphery provided with a rotation portion which has a side provided with at least one locking block;
the locking block of the ballast is inserted through the locking slot of the mounting portion and is locked onto the locking edge of the locking slot to lock the ballast onto the mounting portion of the base.

14. The fluorescent lamp of claim 13, wherein the locking block of the ballast has a substantially L-shaped profile.

15. The fluorescent lamp of claim 13, wherein
the rotation portion of the ballast is movable toward the locking slot of the mounting portion, so that the locking block of the ballast is inserted through the locking slot of the mounting portion;
the rotation portion of the ballast is rotatable relative to the mounting portion of the base, so that the locking block of the ballast is moved to abut the locking edge of the locking slot to lock the ballast onto the mounting portion of the base.

16. The fluorescent lamp of claim 15, wherein
the rotation portion of the ballast is rotatable relative to the mounting portion of the base in the reverse direction, so that the locking block of the ballast is detached from the locking edge of the locking slot and is moved to align with the locking slot of the mounting portion;
the rotation portion of the ballast is movable outwardly relative to the locking slot of the mounting portion, so that the locking block of the ballast is detached from the locking slot of the mounting portion, and the ballast is detached from the mounting portion of the base.

17. The fluorescent lamp of claim 8, wherein the holder of the ballast is perpendicular to the longitudinal direction of the ballast.

18. The fluorescent lamp of claim 10, wherein
the mounting portion of the base is located at a top of the base;
the opening of the reflective shade is located at a top of the reflective shade.
